(19) United States
(12) Patent Application Publication
(10) Pub. No.: US 2025/0120387 A1
(43) Pub. Date: Apr. 17, 2025

(54) PALLET STATION

(71) Applicant: ECOLAB USA INC., Saint Paul, MN (US)

(72) Inventors: DOUGLAS B. GARDNER, Maplewood, MN (US); RASHAAD J. MAYFIELD, Saint Paul, MN (US); DANIEL RONALD SCHWARTZ, Saint Paul, MN (US)

(21) Appl. No.: 18/909,596

(22) Filed: Oct. 8, 2024

Related U.S. Application Data
(60) Provisional application No. 63/589,414, filed on Oct. 11, 2023.

(51) Int. Cl. A01M 23/16

(52) U.S. Cl. CPC A01M 23/16

(57) ABSTRACT

A rodent station can be fit inside a pallet, such as within a fork opening of a pallet. The rodent station includes a multi-functional slide or sled and an end cap. The slide is a flat surface with attachment options that can accommodate rodent traps, insect traps, solid or liquid rodenticide bait placements, attractants, sensing equipment, etc. The end cap is multifunctional in that it can cover the opening, hide and protect the slide or slide assembly, and the end cap can also hold the slide in place. The cover is temporarily secured in place to the interior of the pallet to mitigate pallet jacks and forklifts from damaging the internal components. The securement can be teeth or other tension devices that engage with the pallet to hold the cover in place.

### CROSS REFERENCE TO RELATED APPLICATIONS

This application claims priority under 35 U.S.C. § 119 to provisional patent application U.S. Ser. No. 63/589,414, filed Oct. 11, 2023. The provisional patent application is herein incorporated by reference in its entirety, including without limitation, the specification, claims, and abstract, as well as any figures, tables, appendices, or drawings thereof.

### TECHNICAL FIELD

The present disclosure relates generally to pest control and/or management systems and/or corresponding methods of use. More particularly, but not exclusively, the present disclosure relates to a pest control and/or management apparatus and/or system for use in combination with pallets, such as those that are used to store and/or transport goods.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Pests such as rodents or insects can be a significant problem in a wide range of locations, climates, and situations. For example, rodents such as rats and mice have been a problem to humans for thousands of years and have generally followed humans wherever humans have settled around the world. The problems that rodents can cause are varied. For example, in addition to the loss that they can cause by eating foodstuffs, they may also contaminate foodstuffs by leaving behind various contaminants such as their saliva, feces and/or urine in addition to any other contaminants they may carry. Rodents may also cause damage to the fabric of a building by, for example, chewing wiring or nesting within wall cavities. In addition, rodents may harbor and transmit a number of diseases. They may also carry parasites, such as fleas and ticks. Rodent populations can also grow quickly. Therefore, it is desirable to control and/or eliminate rodent infestation.

Throughout history, humans have devised many solutions for controlling or reducing pest populations and there are presently thousands of businesses whose primary services are the control/reduction of pests.

Distribution and retail environments, such as stores, warehouses, trailers, and the like store goods for sale or that are to be delivered to another location. In order to most efficiently hold and store the goods, often times the goods are placed on pallets, which can then be stored on shelves, in the trailers, on the ground, or on one another. A pallet (also called a skid) is a flat transport structure, which supports goods in a stable fashion while being lifted by a forklift, a pallet jack, a front loader, a jacking device, or an erect crane. A pallet is the structural foundation of a unit load, which allows handling and storage efficiencies. Goods in shipping containers are often placed on a pallet secured with strapping, stretch wrap, or shrink wrap and shipped.

One downside of storing goods, such as food or other perishable goods, in such a manner is that rodents tend to accumulate in such environments. The controlled climate and food sources make it appealing to rodents, including, but not limited to, rats, mice, and the like. Rodent elimination in distribution and retail environments has always been a difficult challenge.

Over the years there has been many attempts to improve the effectiveness and efficiency of rodent elimination efforts in these environments. Most attempts at new innovation have not been around making better rodent traps, but rather creating containment stations and placement methods for existing traps, poisons and monitors for rodents.

“New” station and method ideas continue to be generated to address the need for better solutions in distribution and retail environments. For example, bait placements have been attached to warehouse racking to attract and catch rodents. Rodent stations have been placed on pallets with attractants and rodenticide. Oftentimes, the top side of pallets are used to hold traps and/or poisons in areas of known rodent activity. However, the downside is that the traps and poisons are open to the air with this type of setup.

Additional attempts include tubes integrated with racks or traps added under false tops of the pallets. However, these can be limited in access and make it difficult to check the status of the stations.

Still further issues exist. While pallets are generally manufactured in similar manners, there are differences in the style of pallets, including sizes and makeup. The fork entry openings create pallet movement issues or a direct path to disrupt rodent devices contained inside the pallet, leading to the challenge of how to potentially close or block the entry. Still further, there are no standards that control the pallet sizes, and thus, there may be slight differences in the dimensions of the pallets, which can create issues when attempting to develop rodent stations that could be used for multiple styles, sizes, and/or locations.

Thus, there exists a need in the art for an apparatus that overcomes the issues related to catching, monitoring, and/or killing rodents in such warehouse, distribution, and/or retail centers that utilize racks and pallets.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of any of the aspects of any of the embodiments of the present disclosure to create an improved rodent station for use inside pallets. For example, while the sizes of pallets may vary, generally all have fork entries to allow a forklift to pick up and move the pallet. Therefore, the rodent station disclosed herein is designed to be held at least partially within the fork opening.

It is still yet a further object, feature, and/or advantage of any of the aspects of any of the embodiments of the present disclosure to include both a sled with traps, poisons, attractants, or the like and a cover for enclosing the pallet.

It is still a further object, feature, and/or advantage of any of the aspects of any of the embodiments of the disclosure to disclose a rodent station that will be self-holding in the pallet opening.

It is yet another object, feature, and/or advantage of any of the aspects of any of the embodiments of the disclosure to provide rodent stations of varying sizes.

It is still another object, feature, and/or advantage of any of the aspects of any of the embodiments of the disclosure to include location features that will aid in locating the stations in the environment of use for monitoring, replacement, and/or removal.

The rodent stations disclosed herein can be used in a wide variety of applications. For example, while the disclosure includes that warehouses, distribution centers, retail centers, and the like can benefit from the rodent stations, it should be appreciated that generally any location that utilizes pallets and includes potential pest/rodent infestation could benefit.

It is preferred the apparatus be safe, cost effective, and durable. For example, the rodent stations can be adapted to resist excessive heat, static buildup, corrosion, and/or mechanical failures (e.g., cracking, crumbling, shearing, creeping) due to excessive impacts and/or prolonged exposure to tensile and/or compressive forces acting on the apparatus.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the rodent station.

Methods can be practiced which facilitate use, manufacture, assembly, maintenance, and repair of a rodent station which accomplish some or all of the previously stated objectives.

Any of the rodent stations, including any of the aspects thereof, can be incorporated into systems or kits that accomplish some or all of the previously stated objectives.

According to some aspects of the present disclosure, a rodent station for an internal portion of a pallet comprises a cover comprising a front and a rear; a pallet retention system on the rear of the cover, the pallet retention system comprising an engagement member for engaging an interior portion of a cavity of the pallet and an attachment and release system for the engagement member; and a sled extending away from the pallet retention system at the rear of the cover.

According to at least some aspects of some embodiments of the disclosure, the cover is sized the same or larger than an opening to the cavity of the pallet.

According to at least some aspects of some embodiments of the disclosure, the engagement member of the pallet retention system comprises tabs with outwardly facing teeth that engage the interior portion of the cavity of the pallet.

According to at least some aspects of some embodiments of the disclosure, a first tab extends transversely to the cover and a second tab includes an angled portion extending greater than 90-degrees and a transverse portion from the angled portion with teeth at the end of the transverse portion.

According to at least some aspects of some embodiments of the disclosure, the attachment and release system comprises corresponding apertures.

According to at least some aspects of some embodiments of the disclosure, a hook tool is configured to actuate the apertures of the attachment and release system to selectively engage the engagement member with the interior portion of the cavity of the pallet.

According to at least some aspects of some embodiments of the disclosure, the sled is attached to the cover.

According to at least some aspects of some embodiments of the disclosure, the sled is a separate member from the cover, and wherein the sled is positioned in the interior portion of the cavity of the pallet.

According to at least some aspects of some embodiments of the disclosure, the rodent station further comprises traps, attractants, and/or rodenticide positioned at the sled.

According to additional aspects of the present disclosure, in combination, a pallet and a rodent station comprises a pallet comprising a upper level, a lower level, and at least one interior cavity between the upper and lower levels; a rodent station positioned in the at least one interior cavity of the pallet, the rodent station comprising a cover comprising a front and a rear, a pallet retention system on the rear of the cover, the pallet retention system comprising an engagement member for engaging the at least one interior a cavity of the pallet, and a sled extending away from the pallet retention system at the rear of the cover.

According to at least some aspects of some embodiments of the disclosure, the cover is sized the same or larger than an opening to the at least one interior cavity of the pallet.

According to at least some aspects of some embodiments of the disclosure, the engagement member of the pallet retention system comprises tabs with outwardly facing teeth that engage the at least one interior cavity of the pallet.

According to at least some aspects of some embodiments of the disclosure, said tabs are selectively movable to engage and disengage with the at least one interior cavity of the pallet.

According to at least some aspects of some embodiments of the disclosure, the sled is attached to the cover.

According to at least some aspects of some embodiments of the disclosure, the engagement member comprises an extendable member that extends to engage the at least one interior cavity of the pallet and that retracts to disengage.

According to additional aspects of the present disclosure, a rodent station, comprises a cover comprising a front and a rear, said cover sized to conceal the opening to an interior cavity of a pallet; an engagement member at the rear of the cover, the engagement member including one or more portions that can engage and disengage a portion of the interior cavity of the pallet to hold the station in place and allow removal therefrom; and a sled extending transversely from the rear of the cover, the sled configured to hold traps, attractants, and/or rodenticide.

According to at least some aspects of some embodiments of the disclosure, the engagement member comprises tabs extending from the rear of the cover and teeth at the distal ends of the tabs, wherein the teeth extend transversely to the tabs for selective engagement with the interior cavity of the pallet.

According to at least some aspects of some embodiments of the disclosure, at least one of the tabs includes an angled portion greater than 90-degrees to allow for movement of the tab for the selective engagement of the teeth.

According to at least some aspects of some embodiments of the disclosure, the engagement member comprises an extendable member that extends to engage the portion of the interior cavity of the pallet and that retracts to disengage.

According to at least some aspects of some embodiments of the disclosure, the sled is unconnected from the cover.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1A is a perspective view of an example of a stringer pallet showing features thereof.

FIG. 1B is a perspective view of an example of a block pallet showing features thereof.

FIG. 2 is a front perspective view of a rodent station for use with pallets according to aspects and/or embodiments of the present disclosure.

FIG. 3 is rear perspective view of the rodent station of FIG. 2.

FIG. 4 is a top plan view of the rodent station of FIG. 2.

FIG. 5 is a front elevation view of the rodent station of FIG. 2.

FIG. 6 is a rear elevation view of the rodent station of FIG. 2.

FIG. 7 is a side elevation view of the rodent station of FIG. 2.

FIG. 8 is a front elevation view of a pallet retention system for use with a rodent station according to aspects and/or embodiments of the present disclosure.

FIG. 9 is a perspective view of an additional version of a sled for use with a rodent station according to aspects and/or embodiments of the present disclosure.

FIG. 10 is a view of a tool for manipulating the pallet retention system of a rodent station according to aspects and/or embodiments of the present disclosure.

FIG. 11 is a view showing a sled, such as the sled of FIG. 9, positioned within an interior cavity of a pallet.

FIG. 12 is a view showing the cover of a rodent station positioned relative to a pallet.

FIG. 13 is a view showing the manipulation of the rodent station with the tool to disengage pallet retention system from the pallet.

FIG. 14 is a view showing the manipulation of the rodent station with the tool to engage pallet retention system from the pallet.

FIG. 15 is a view of a rodent station with traps, attractants, and/or rodenticide positioned at the sled.

FIG. 16 is a view of another version of the cover of a rodent station showing additional features.

FIG. 17 is another view of the rear of the cover of a rodent station showing additional features of the station.

An artisan of ordinary skill in the art need not view, within isolated figure(s), the near infinite distinct combinations of features described in the following detailed description to facilitate an understanding of the present disclosure.

### DETAILED DESCRIPTION

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

A pallet (also called a skid) is a flat transport structure, which supports goods in a stable fashion while being lifted by a forklift, a pallet jack, a front loader, a jacking device, or an erect crane. A pallet is the structural foundation of a unit load, which allows handling and storage efficiencies. Goods in shipping containers are often placed on a pallet secured with strapping, stretch wrap, or shrink wrap and shipped. In addition, pallet collars can be used to support and protect items shipped and stored on pallets. These are often found during transport or in storage or retail facilities (e.g., warehouses, retail centers, etc.). While most pallets are wooden, pallets can also be made of plastic, metal, paper, and recycled materials.

Pallets make it easier to move heavy stacks. Loads with pallets under them can be hauled by forklift trucks of different sizes, or even by hand-pumped and hand-drawn pallet jacks. Movement is easy on a wide, strong, flat floor: concrete is excellent. The greatest investment needed for economical pallet use is in the construction of commercial or industrial buildings. Ability to pass through standard doors and buildings make handling more convenient.

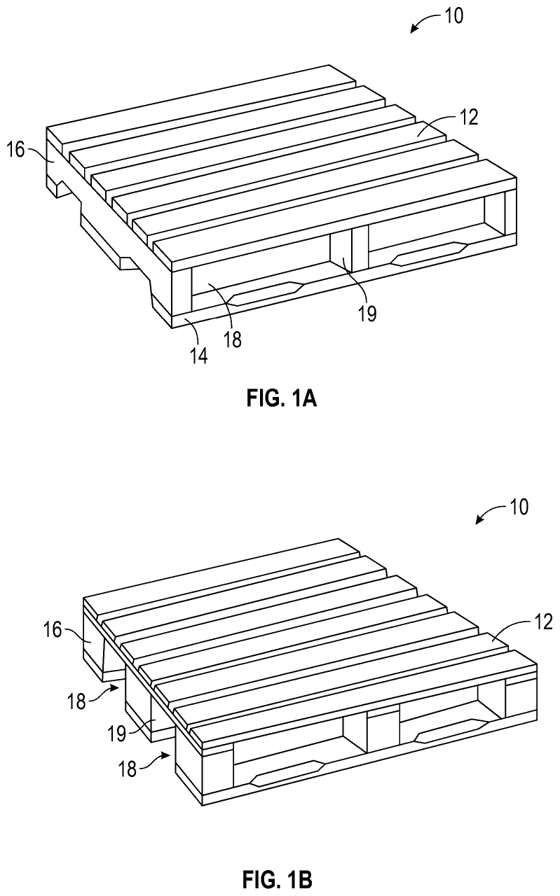

An example of a stringer pallet 10 is shown in FIG. 1A, and a block style pallet 10 is shown in FIG. 1B. Generally, pallets such as that shown in FIGS. 1A/1B comprise an upper portion 12, which may be referred to as a deckboards. This is the surface that supports goods. A bottom portion 14 may comprise less boards than the upper portion 12. A number of supports 16 are provided between the lower portion 14 and upper portion 12. These are also referred to as stringers 16 in FIG. 1A, and blocks in FIG. 1B. The stringers and blocks 16 are spaced from one another to create cavities 18, which may also be referred to as lift openings. Arms of forklifts or jacks can be inserted into the cavities 18 to lift and move one or more pallets, including any goods that may be stacked or stored thereon. Still further, it should be noted that the cavities 18 include interior portions 19 of the stringers or blocks 16, which are the interior facing walls or faces of the boards. Though some major standards exist, there are no universally accepted standards for pallet dimensions. Companies and organizations utilize hundreds of different pallet sizes around the globe. While no single dimensional standard governs pallet production, a few different sizes are widely used.

The standard 48×40 North American pallet, or GMA pallet, has stringers of 48-inches and deckboards of 40-inches, and was standardized by the Grocery Manufacturers Association (GMA). A standard wooden pallet (48 in×40 in×6 in or 1,219 mm×1,016 mm×152 mm) with a static load bearing capacity of 3-short-tons (2.7 long tons; 2.7 t) and a 1-short-ton (0.89-long-ton; 0.91 t) dynamic capacity, will weigh approximately 33 to 48 lb. (15 to 22 kg). GMA pallets typically weigh 37 pounds (17 kg) and are 6 and ½ inches (170 mm) tall. Their deck boards measure 3 and ¼ inches (83 mm) wide and are 5/16 inch (7.9 mm) thick each. Other dimensions of pallets have different weight capacities.

While pallets may have different sizes and no particular standard, it should be noted and appreciated that the aspects of rodent stations as will be disclosed herein will be able to be used with any pallet having the openings for lifts and having an interior portion as well.

As noted, one downside to having large storage facilities with goods (in particular, foodstuff) stored on pallets is that they attract rodents and other pests. It can be difficult to capture, trap, or eliminate the rodents, especially for facilities that have stacks and stacks of pallets containing foodstuff.

Therefore, to address the issues of rodents and pests, the disclosure includes numerous embodiments and aspects thereof that provide for rodent stations 20 to attract, trap, and/or eliminate the rodents in novel manners. It has been shown that the interior portions of the pallets, e.g., the area between the upper deckboards 12 and the lower portion under the stringer or block boards 16, which may be floorboards 14, are areas that allow the rodents to move throughout the pallets to evade capture by previously used traps. Thus, as will be understood, the rodent stations 20 provided are intended to be located at least partially within this area, which will address long felt needs in the art.

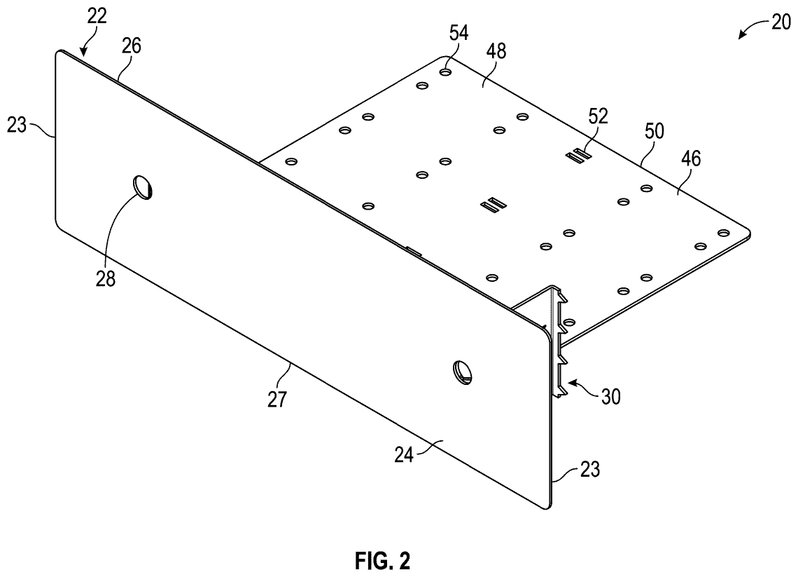

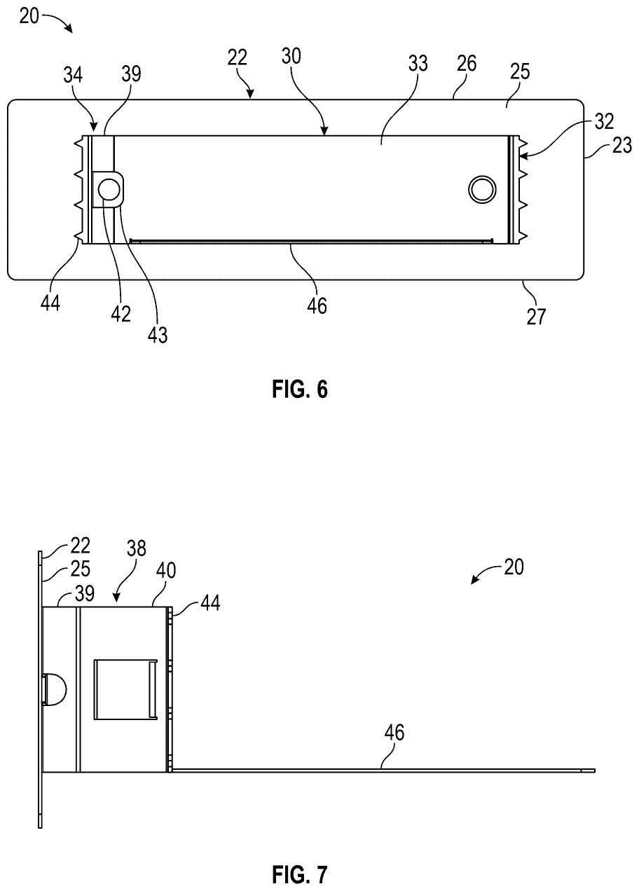

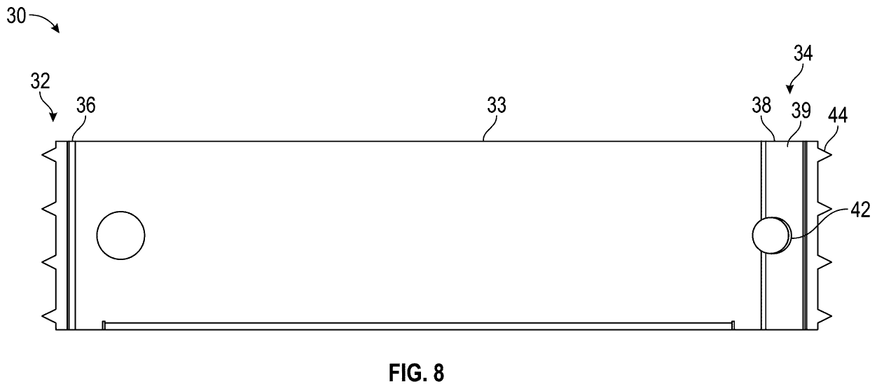

FIGS. 2-7 disclose a rodent station 20 that is configured to be placed and utilized in such an area in the interior 19 of a pallet 10, which is in the opening 18 for lifts and framed by stringer or block boards 16 on both sides. As shown in the figures, the rodent station 20 includes a cover or front plate 22. The cover 22 is sized to be at least the same size as the forklift opening 18 of the pallet 10. However, according to preferred embodiments, the cover 22 is sized larger than the opening 18. This will mitigate gaps between the outer periphery of the cover 22 and the opening 18 to allow for rodents to pass through.

The cover 22 includes a front surface 24 and a rear surface 25. The front surface 24 is the side that faces away from the pallet 10, while the rear surface 25 is the side that faces towards the interior 19 of the pallet 10. The front surface 24 and/or rear surface 25 of the cover 22 may be planar or it may include projections extending from either of the sides. The cover can comprise a rigid material, such as sheet metal (e.g., 14-gauge), plastic, wood, other metal, or any other material capable of supporting the system.

As will be understood, projections or other additions (including, but not limited to, reflective tape, lights, audio features, QR codes or other identifying labels, as well as any other tags, tapes, stickers, or the like) may be added to improve the identification and/or location of the rodent stations 20. This will be useful in facilities, such as when there are multiple pallets, and there is a desire to remove any of the rodent stations before any of the pallets are removed. In addition, there are shown apertures 28 in the cover 22 from the front surface to the rear surface. For embodiments that include certain attachment and release systems 34, the apertures 28 will be used. This will be described in greater detail herein.

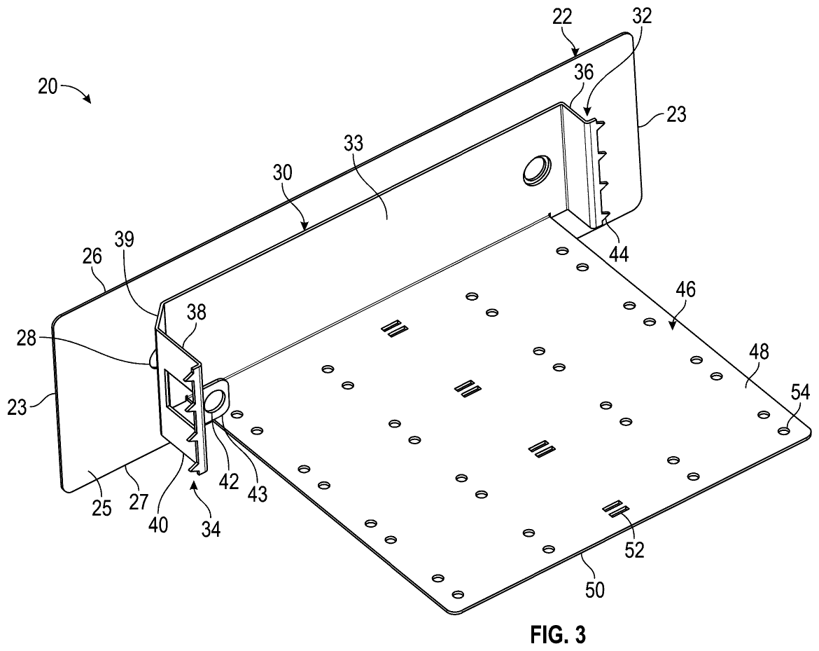

The rear surface 25 of the cover 22 includes additional features of the rodent station 20. As shown in FIG. 3, a pallet retention system 30 and sled 46 are positioned at the rear surface 25. The pallet retention system 30 is a way to hold the rodent station 20 in place in the interior 19 of the pallet 10, such as in the forklift openings. The sled 46 is a way to attach items that will aid in controlling rodents and pests using the rodent station 20.

The pallet retention system 30 is shown to include a base portion 33 at the rear surface 25 of the cover 22. The base 33 may not be needed in all embodiments but does provide a way to connect features of the retention system. The base 33 can also comprise metal, such as sheet metal, allowing it to be welded to the rear surface 25 of the cover 22. The base 33 will generally conform or match the cover 22 to mitigate gaps between the objects. For example, the base can have apertures that align with the cover apertures 28. However, as the base 33 is a way to connect the retention system 30, the size, shape, and overall configuration of the base 33 should not be limiting, and it should be appreciated that it is used to connect and therefore, any configuration can be used. In addition, when different materials are used, the attachment can be varied. Instead of welding, or in addition to welding, the base can be attached via adhesives, sonic welding, mechanical fasteners, or some combination thereof. In addition, the base and cover could be integrally made, such as by molding, forming, or other.

Extending away from the rear surface 25 of the cover 22, and when the base 33 is included, the base 33 as well, is an attachment and release system 34 that includes engagement members 32. The system includes a first tab 36 and a second tab 38. The first tab 36 is shown to be formed by bending a portion of the sheet metal base 33 approximately 90-degrees therefrom to extend rearwardly. However, the 90-degrees is not to be limiting, and the first tab 36 may extend any angle rearwardly from the base 33. At a distal end of the first tab 36 is an engagement member 32 in the form of a plurality of teeth 44. The number of teeth 44 are not to be limiting. As will be understood, the teeth 44 are configured to interact with (i.e., at least partially contact into) a portion of the interior 19 of the pallet 10. For example, when the rodent station 20 is positioned in the interior 19 of the pallet 10, the teeth 44 may contact and partially extend into a stringer, block, or spacer board 16. This will aid in holding the rodent station 20 in place and provide support.

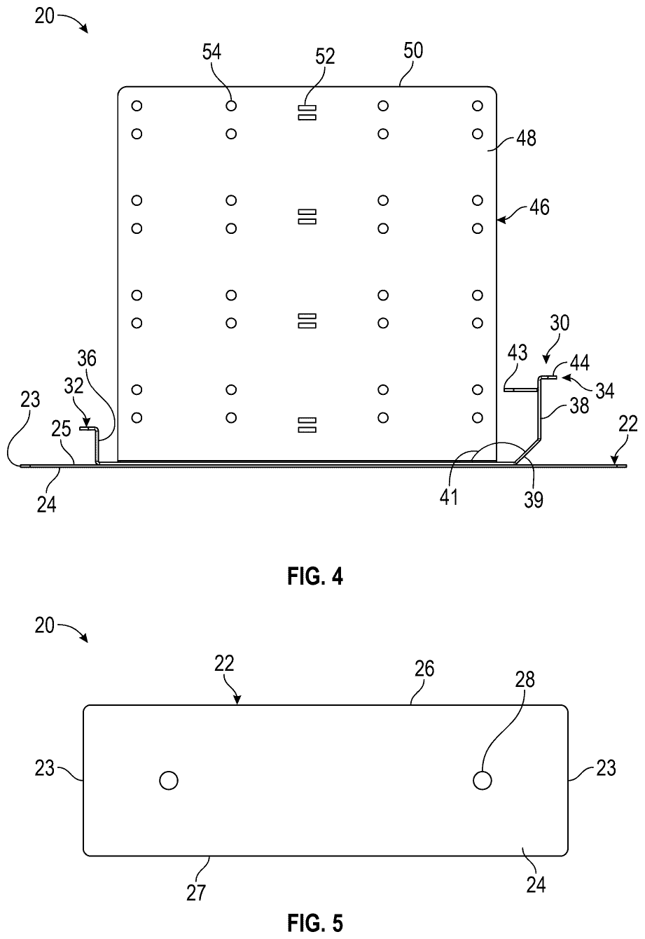

At the opposite side from the first tab 36 is a second tab 38. The second tab 38 also extends away from the cover 22, such as being bent from the base 33. However, the second tab 38 includes additional features that aid the attachment and release system 34. The second tab 38 includes two sections, an angled portion 39 and a transverse portion 40. The angled portion 39 extends from the base 33 at an angle greater than 90-degrees (see, e.g., the angle 41 shown in FIG. 4). According to some embodiments, the angle 41 is approximately 135-degrees. However, the angle can be more or less than that and need not be exact. The transverse portion 38 is shown to be approximately 90-degrees relative to the cover 22/base 33.

While it has been provided that the second tab 38 includes an angled portion and a relatively 90-degree portion, this is not the only manner to provide such a tab. For example, this formed section could be an arc instead of two discrete bends. A goal of the feature is flexing without causing deformation and either are suitable. Therefore, it should be appreciated that other configurations that allow for flexing and durability to mitigate deformation would be suitable.

As will be understood, the second tab 38 is manipulated (moved) to engage/disengage with a portion of the interior 19 of the pallet. The angled portion 39 creates a section that can move with less failure to allow for greater uses of the device before any potential failure thereof.

Additional features of the second tab 38 include a hole tab 43 with aperture 42 therethrough. The hole tab 43 is shown to be a cutout and bent portion of the transverse portion 40 of the second tab 38, but it could also be a separate component that is welded or otherwise affixed to the tab. The aperture 42 aligns with the aperture 28 of the cover 22 and also an aperture through the base 33/angled portion 39 of the second tab 38. As will be understood, a hook tool 70 can be used to extend through the aligned apertures to manipulate (i.e., bend or move) the second tab 38 to engage/disengage teeth 44 that are positioned at the distal end of the second tab 38.

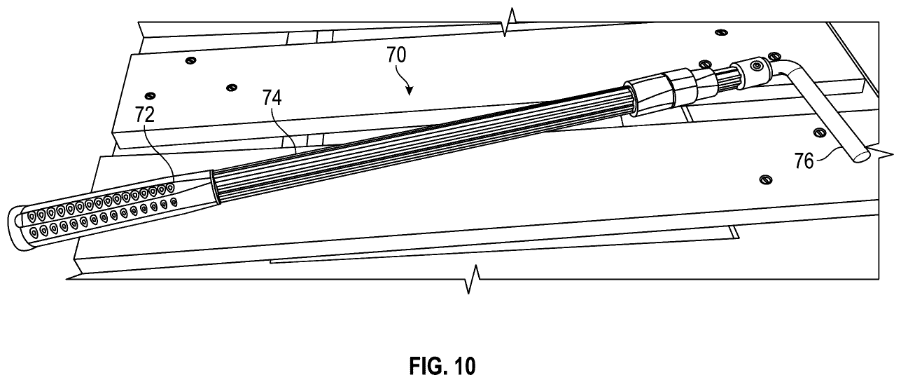

FIG. 4 shows a view of the tabs 36, 38 and attach and release system 34. As noted, the teeth 44 on both of the tabs will be used to contact/engage one or more interior portions of the pallet, such as at two separate spacer/springer boards 16 of the pallet. The tabs 36, 38 can be biased in an outward manner, which would force the teeth towards an interior portion of the pallet. Alternatively, the tabs could be unbiased but urged into and out of engagement with the portion of the pallet with a tool, such as will be explained herein. For example, when the attachment and release system 34 is of the type shown in FIGS. 2-7, a tool such as a hook tool 70, as shown in FIGS. 10, 13, and 14 could be used.

The tool 70, which may also be referred to as a hook tool, includes a handle 72 at a first end. The handle may include a grip portion or texture to aid in the grip of the tool. The handle may be rubber or other polymer material or may be knurled steel. An elongated shaft 74 extends from the handle 72. The handle 72 may cover a portion of the elongated shaft 74. The shaft can be a fixed length or adjustable in length, such as being telescoping. The shaft comprises a rigid material, such as including, but not limited to, steel or other metal, plastic, wood, or the like. At a distal end of the shaft 74 is a hook 76. The hook 76 is shown to be a separate member attached to the shaft 74, but the hook 76 could comprise the same material, making it an integral device. The hook 76 is an angled portion relative to the shaft 74. According to some embodiments, the hook 76 is angled approximately 90-degrees relative to the shaft, but the angle could be more or less than 90-degrees.

According to some aspects of some embodiments, the hook tool 70 is used in conjunction with the tabs 36, 38 of the attachment and release system 34 to engage and disengage portions of the pallet, which allow for positioning, securing, and removal of the rodent station to the interior of the pallet 10.

For example, as previously noted, the cover 22 and retention system 30 includes a number of apertures, such as cover apertures 28, first tab aperture, and hole tab aperture 42. The hook portion 76 is configured to extend through aligned holes/apertures. Rotating the tool 70 when positioned through aligned holes (e.g., holes 28 and 42) will move the second tab 38 inwardly or outwardly to press the teeth 44 of the second tab 38 into and out of contact with a board in the interior of the pallet 10.

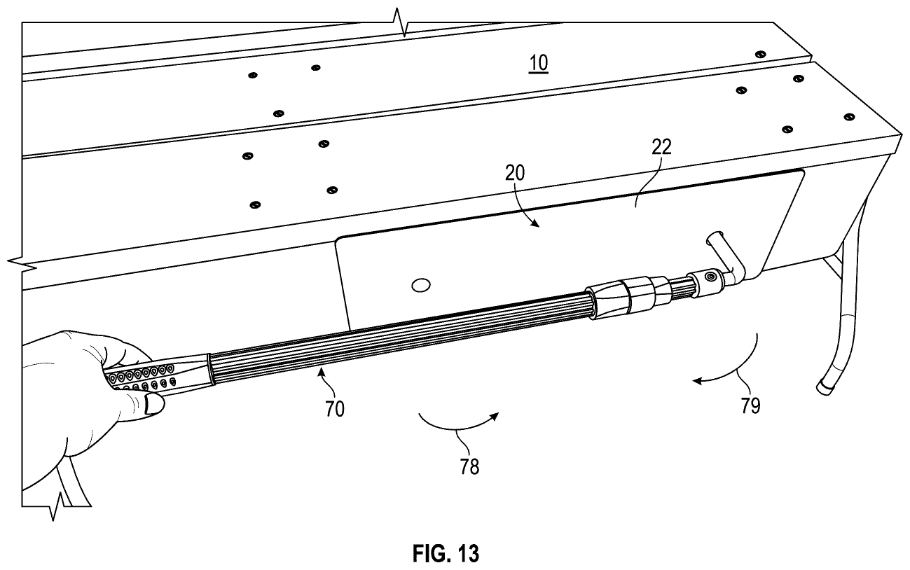

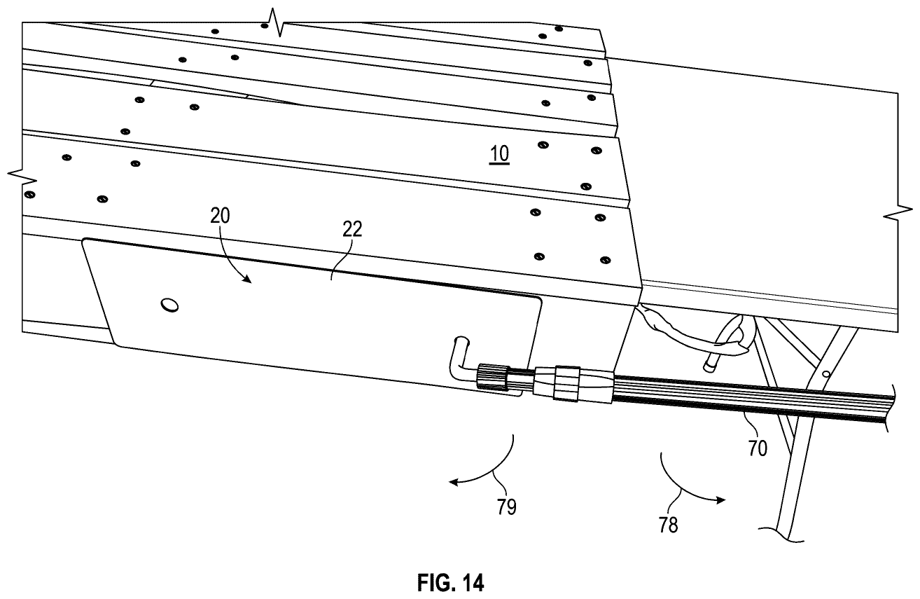

FIGS. 13 and 14 are illustrative of such an example use of the tool 70 and rodent station 20. As shown in FIG. 13, the hook 76 of the tool 70 has been inserted into the aligned holes, including the aperture 42 on the tab of the second tab 38. Opposite arrows 78, 79 are provided to show how the tool can be manipulated. For example, moving the tool 70 in the direction of the first arrow 78, such as at the handle 72, will bend the second tab 38 to move the teeth 44 of the second tab away from the pallet boards, which will disengage the teeth to allow for the removal of the rodent station from the interior of the pallet. Moving the tool in the direction of the second arrow 79 will urge the teeth into contact and engagement with the pallet, which will aid in holding the rodent station in place in the interior of the pallet.

FIG. 14 is a similar view but showing the tool 70 inserted in an opposite orientation. When inserted in this manner, the movement in the direction of the first arrow 78 will again disengage the teeth 44 from the pallet, while the movement and rotation in the second direction 79 will engage the teeth to the pallet. Thus, the simple and easy to use engagement and retention system 30 will both hold the rodent station in place in the interior of the pallet, while allowing for quick and easy removal of the same from the pallet.

However, it should be noted that other types of engagement and/or retention can be used. For example, the teeth 44 can be on tabs that are spring loaded. In addition, an extending member, such as a pneumatic member or actuating member could be used. In such a setup, the extending member could be activated to extend into contact with opposing walls or boards of the pallet to hold the extension member, and thus, rodent station, in place in the interior of the pallet. Still additional members could be used, such as a compression member that will engage with the wood of the pallet to hold in place. Mechanical means, such as expanding screws, joints, or other expanding portions could be used to provide the forces to hold the rodent station in place in the pallet. Additional ways to secure the sled and cover of the rodent station can include screws into the pallet or adjustable members that could be a linear toggle clamp that is threaded to proper fit tightness to secure the rodent station in place in the interior of the pallet.

Referring back to the figures, additional aspects of at least some embodiments of the rodent station 20 include a sled 46 extending from the rear surface 25 of the cover 22. In FIGS. 2-7, the sled 46 is connected, such as by welding, mechanical fasteners, or being integral with the cover 22. Thus, the cover 22 and sled 46 can be considered a single piece, either connected or integrally composed. The sled 46 has a sled body 48. The sled body 48 can comprise sheet metal or other rigid materials and is sized to fit within a fork opening or other opening of the pallet 10. As shown in FIG. 4, the sled 46 has a width that is less than the cover and also less than the tabs of the retention system 30. This will ensure that the sled 46 fits in the opening. The length of the body 48 can be as long as desired, such as based upon the number of additions that are added to the sled to attract, catch, and/or kill rodents. The body has a distal end 50 at the length.

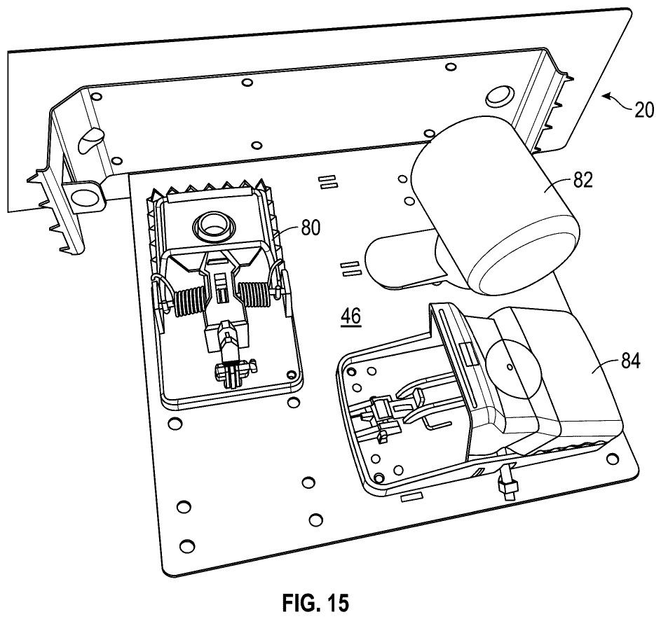

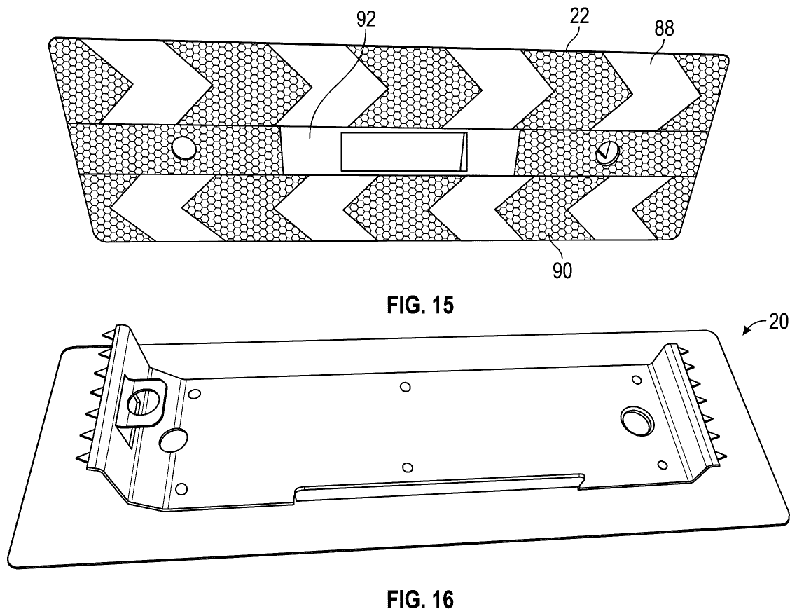

To attach the additions (i.e., traps 80, attractants 82, rodenticide 84, or otherwise), a number of features are included with the sled body 48. As shown in the figures, the sled body can include any number, orientation, stye, and/or design of attachment points. This can include, but are not limited to, bridge lances 52 and apertures 54. For both or either of the bridge lances 52 and apertures 54, zip ties 86, rope, ties, mechanical or non-mechanical fasteners could be used to connect the additions to the sled 46. For example, FIG. 15 is a view showing a trap 80 (such a trap could be a spring activated rodent trap, glue board or other adhesive, or any other mechanism that can hold, temporarily or permanently, a rodent, either in an alive or dead capacity), rodenticide apparatus 84, and attractant 82 attached to the sled at apertures or bridge lances using zip ties. Note that this is for example purposes, and any number, configuration, or style of additions for aid in removing rodents via the rodent station 20 are contemplated.

However, other types of attachments to the sled could be used. For example, magnets could be used to attach traps 80, attractants 82, rodenticide 84, or otherwise to portions of the sled, such as tracks that are added to the sled.

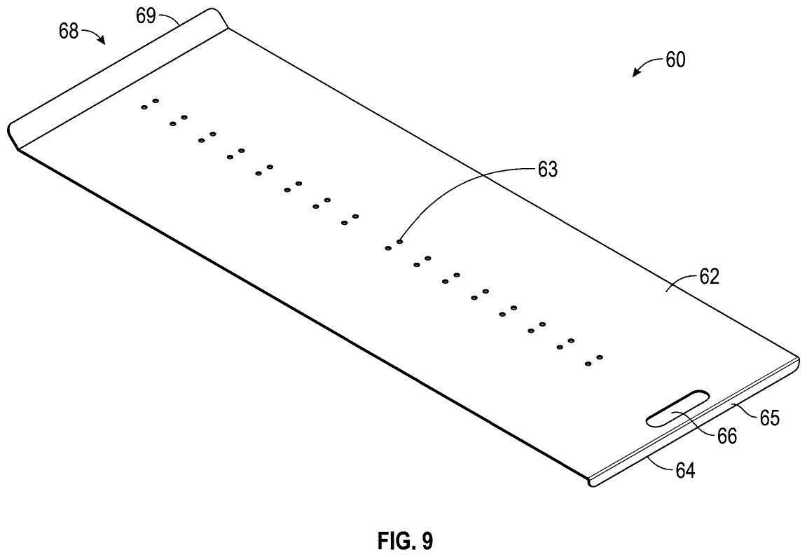

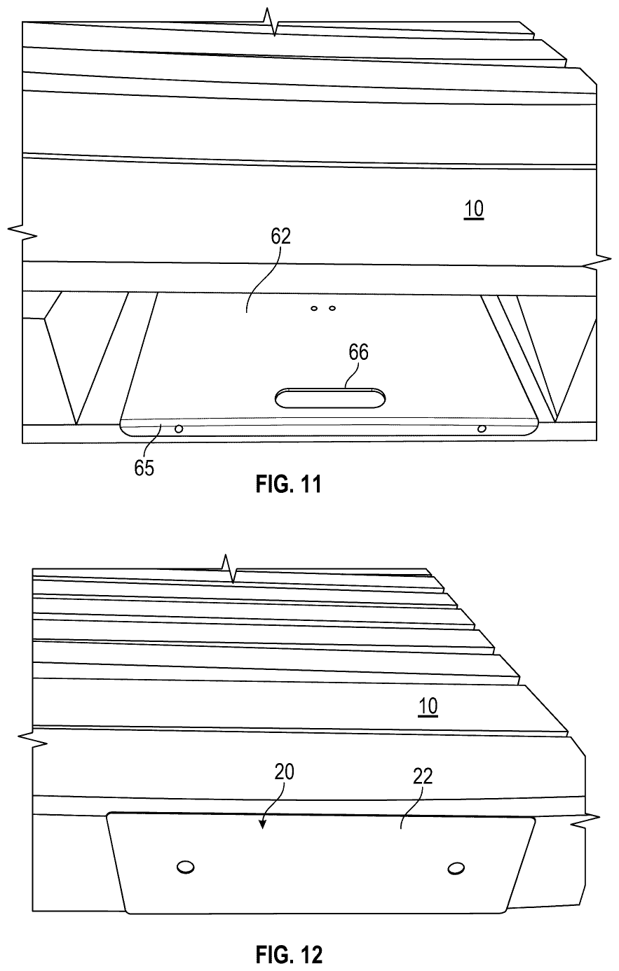

FIG. 9 shows an additional embodiment of a sled 60, which is not attached in any manner to the cover 22. The sled 60 is a bit longer than the attached sled 46. The sled 60 includes a front end 64 and a rear or distal end 68. A sled body 62 extends between the ends, and includes a number of apertures 62, bridge lances, or other attachment points. A front flange 65 is at the front end 64 and is oriented generally downward. At or near the front end 64 is a grip 66. As shown in FIG. 11, when the sled 60 is positioned in the interior of a pallet 10, the flange 65 will engage a front portion of the pallet 10. The grip portion 66 allows for movement or other manipulation of the sled 60. As shown in FIG. 11, the front flange 65 may include apertures, which can allow mechanical attachment to a portion of the pallet 10. Note that the width of the sled body 62 is less than the width of the interior of the pallet, which allows the sled to fit therein. At the rear or distal end 68 of the sled 60 is a rear flange 69. The figure shows the rear flange 69 upwardly oriented. This mitigates the distal end from catching a part of the pallet during insertion or removal by sliding the sled in place.

As noted, the larger sled 60 allows for more spacing for attachments or more attachments for attracting, catching, and/or killing the rodents and other pests. As shown in FIG. 12, the cover 22 with retention system 30 (e.g., tabs with teeth 44) could be placed over the opening into the pallet 10 to cover the same. As noted, the cover 22 is sized generally larger than the opening into the interior of the pallet. This will provide needed support and mitigation of gaps for rodents to enter or leave the interior via the cover or opening.

In any embodiment where the sled is connected or unconnected from the cover, it should be appreciated that the cover provides protection and tamper resistance for the rodent station 20.

In addition, a number of variations, alternatives, additions, etc. could be part of the rodent station 20. While traps, bait, and attractants (lethal and non-lethal) have been disclosed, it should be appreciated that additional additions be added to the sled portions. These could include, but are not limited to, cameras, sensors (note presence of a rodent), speakers, or other devices could be added. These could aid in the detection and removal of pests, or even aid in the location determination of the rodent stations so that they are not removed if or when a pallet is removed.

Still further, features could be added to the cover itself, such as on the front face 24 of the cover 22. See, e.g., FIG. 16, which includes cover features 88. Such features can include, but are not limited to, reflective tape 90, labels 92, QR codes, bar codes, air tags, or other sensors. These features could include such technology as ultra-wideband, WiFi, cellular technologies, Bluetooth, or other radio technology to allow for location tracking. Such features can aid in finding the rodent stations in locations where many pallets are used. In addition, the features, such as the labels or codes can provide information on the rodent station 20. Such information can include, but is not limited to, date of insertion, ownership information, number and/or type of attachments used with a particular station, identification that a trap has been activated (i.e., a rodent or pest has been caught), or other information related to the use of the rodent station in order to better use the station and control the rodent issues.

As noted throughout, aspects of the disclosure include features that can be attached with mechanical or non-mechanical fasteners. In general, a mechanical fastener is a device that is used to mechanically join or fasten two or more objects together. In general, fasteners are used to create non-permanent joints or connections; that is, joints that can be removed or dismantled without damaging the joining components. General types of mechanical fasteners can include threaded (bolts, screws, nuts, studs, etc.) or non-threaded (keys, pins, retaining rings, etc.). Additional fasteners can include, but are not limited to nails, rivets, and the like. Non-mechanical fasteners may include adhesives, fittings, clearance fittings, friction fittings, compression fittings, transition fittings, snaps, snap fits, hook and loops, joints, welding, and the like. For simplistic purposes, screws, nuts, bolts, pins, rivets, staples, washers, grommets, latches (including pawls), ratchets, clamps, clasps, flanges, ties, adhesives, welds, any other known fastening mechanisms, or any combination thereof may be used to facilitate fastening, may be used for any of the connections described herein and all are to be considered swappable with one another for any of the attachment, connection, and/or fastening of components, either temporarily or permanently.

It is further considered that any combination of any of the listed mechanical and/or non-mechanical fasteners or methods of fastening are to be considered a part of the disclosure.

Therefore, a rodent station for use in the interior of a pallet, such as in a fork or other lift opening, has been shown and described. As will be understood, numerous changes, variations, and/or alternatives can be made to any of the embodiments disclosed, which are within the invention, whether explicitly disclosed or not. In addition, while some aspects and/or embodiments have been disclosed and/or shown, it should be appreciated that these are not limiting, and that any possible combination of any of the aspects or features disclosed or shown can be combined in any manner, whether disclosed or not, to create rodent stations covered by the present disclosure.

1. A rodent station for an internal portion of a pallet, comprising:
a cover comprising a front and a rear;
a pallet retention system on the rear of the cover, the pallet retention system comprising an engagement member for engaging an interior portion of a cavity of the pallet and an attachment and release system for the engagement member; and
a sled extending away from the pallet retention system at the rear of the cover.

2. The rodent station of claim 1, wherein the cover is sized the same or larger than an opening to the cavity of the pallet.

3. The rodent station of claim 1, wherein the engagement member of the pallet retention system comprises tabs with outwardly facing teeth that engage the interior portion of the cavity of the pallet.

4. The rodent station of claim 3, wherein a first tab extends transversely to the cover and a second tab includes an angled portion extending greater than 90-degrees and a transverse portion from the angled portion with teeth at the end of the transverse portion.

5. The rodent station of claim 1, wherein the attachment and release system comprises corresponding apertures.

6. The rodent station of claim 5, wherein a hook tool is configured to actuate the apertures of the attachment and release system to selectively engage the engagement member with the interior portion of the cavity of the pallet.

7. The rodent station of claim 1, wherein the sled is attached to the cover.

8. The rodent station of claim 1, wherein the sled is a separate member from the cover, and wherein the sled is positioned in the interior portion of the cavity of the pallet.

9. The rodent station of claim 1, further comprising traps, attractants, and/or rodenticide positioned at the sled.

10. In combination, a pallet and a rodent station comprising:
a pallet comprising an upper level, a lower level, and at least one interior cavity between the upper and lower levels;
a rodent station positioned in the at least one interior cavity of the pallet, the rodent station comprising a cover comprising a front and a rear, a pallet retention system on the rear of the cover, the pallet retention system comprising an engagement member for engaging the at least one interior a cavity of the pallet, and a sled extending away from the pallet retention system at the rear of the cover.

11. The combination of claim 10, wherein the cover is sized the same or larger than an opening to the at least one interior cavity of the pallet.

12. The combination of claim 10, wherein the engagement member of the pallet retention system comprises tabs with outwardly facing teeth that engage the at least one interior cavity of the pallet.

13. The combination of claim 12, wherein said tabs are selectively movable to engage and disengage with the at least one interior cavity of the pallet.

14. The combination of claim 10, wherein the sled is attached to the cover.

15. The combination of the claim 10, wherein the engagement member comprises an extendable member that extends to engage the at least one interior cavity of the pallet and that retracts to disengage.

16. A rodent station, comprising:
a cover comprising a front and a rear, said cover sized to conceal the opening to an interior cavity of a pallet;
an engagement member at the rear of the cover, the engagement member including one or more portions that can engage and disengage a portion of the interior cavity of the pallet to hold the station in place and allow removal therefrom; and
a sled extending transversely from the rear of the cover, the sled configured to hold traps, attractants, and/or rodenticide.

17. The rodent station of claim 16, wherein the engagement member comprises tabs extending from the rear of the cover and teeth at the distal ends of the tabs, wherein the teeth extend transversely to the tabs for selective engagement with the interior cavity of the pallet.

18. The rodent station of claim 17, wherein at least one of the tabs includes an angled portion greater than 90-degrees to allow for movement of the tab for the selective engagement of the teeth.

19. The rodent station of claim 16, wherein the engagement member comprises an extendable member that extends to engage the portion of the interior cavity of the pallet and that retracts to disengage.

20. The rodent station of claim 16, wherein the sled is unconnected from the cover.
